(19) United States
(12) Patent Application Publication
(10) Pub. No.: US 2012/0053033 A1
(43) Pub. Date: Mar. 1, 2012

(54) PROTECTIVE CAP FOR BEING DISPOSED AT AN OUTLET OPENING OF AN APPARATUS FOR PROVIDING DUNNAGE AS WELL AS APPARATUS WITH SUCH A PROTECTIVE CAP

(76) Inventors: Stefan Sprick-Schuette, Bielefeld (DE); Oliver Schmidt, Meensen (DE)

(21) Appl. No.: 13/260,889

(22) PCT Filed: Apr. 1, 2010
(86) PCT No.: PCT/EP10/02115

§ 371 Date: Nov. 14, 2011

(30) Foreign Application Priority Data
Apr. 1, 2009 (DE) 102009015855.3-27

(51) Int. Cl. B31B 49/00

(52) U.S. Cl. 493/38

(57) ABSTRACT

A Protective cap is provided for being disposed at an outlet opening of an apparatus for providing dunnage, comprising an annular, circular, rigid base mountable at the outlet opening, a plurality of rigid swing blades at least partially extending radially inwards from the base, and an articulation arrangement for pivotably connecting the swing blades to the base. The annular base is elastically deformable and slotted radially to form two opposite ring ends such that following an elastic deformation, during which the ring ends slide past each other, the base releases clamping forces radially directed outwards in a circlip-type manner.

The invention relates to a protective cap for an outlet opening of an apparatus for providing dunnage, and to an apparatus with such a protective cap. A well proven dunnage apparatus is known for example from DE 10 2005 053 319 A1 having a receiving organ for holding a paper web rolled up into a reel. In order to provide dunnage in the desired density the paper is reeled off the inside of the reel with a high speed of about 60 to 80 m/min and is fed to a forming device that shapes the paper web in order to produce the dunnage, which for example is to be inserted between goods to be packed and a transport box. The dunnage material receiving organ holds the paper web in such a manner that the longitudinal axis of its reel is essentially parallel to the feeding and transport direction towards the forming device.

The known apparatus for providing dunnage has a housing support featuring an outlet opening for dispensing dunnage material shaped into dunnage or filler material, which outlet opening is facing away from the receiving organ. The forming device is positioned upstream from the outlet opening with respect to the dunnage material transport direction. The forming device is formed by two toothed wheels engaging with each other and arranged in parallel.

It became apparent that an operating person is inclined to manually access the forming device by passing through the outlet opening in cases of a dunnage material jam between the receiving organ and the forming device. In case of such an imprudent manual reaching into the apparatus it can occur that inadvertently the forming device is powered and therefore an injury, in particular a contusion of the hand of the operating person could occur.

A dunnage material shaping apparatus without motor is known form W02006/047696 A2, in which the dunnage material is disposed in a leporello stack inside a box-shaped housing. The forming device comprises a dispensing opening, the dimensions of which are narrow to an extent that the dunnage material is given the desired shaping during its passage. Several flexible engagement flaps are provided at the dispensing opening, radially extending inwards, intended to hold the end of the paper web/dunnage material such that a renewed ergonomically simple and free access to the paper web is possible without having to reach deeply into the dispensing opening. However, the flexible engagement flaps cannot prevent an operating person to reach into the inside of the housing, and are not intended to do so.

It is an object of the invention to overcome the disadvantages of the prior art, in particular to create a protective cap for an outlet opening of an apparatus for providing dunnage that excludes as much as possible the danger of injury to an operating person caused by reaching into the apparatus without impeding the flow of dunnage from the apparatus, in particular without having to accept a reduction of the transport speed, wherein an easy mounting and demounting of the protective cap shall be assured to prevent wear and tear.

This object is achieved through the features of claim 1. Accordingly, a protective cap is provided to be positioned at an outlet opening of an apparatus for providing dunnage, wherein the protective cap has an annular, circular and rigidly elastic base to be mounted at the outlet opening. Furthermore, the protective cap has several rigid swing blades at least partially extending radially from the base towards the inside. Therein, the stiffness of the swing blades is intended to at least impede reaching into the dunnage apparatus through the passage opening by an operating person, thus reducing the danger of injury by the forming device. Furthermore, the protective cap according to the invention has an articulation arrangement for pivotably connecting the swing blades to the base. The annular base is elastically deformable and slotted radially to form two opposite ring ends in such a manner that following an elastic deformation during which the ring ends of the slotted base essentially slide past one another in circumferential direction, the base generates and transmits clamping forces directed radially outwards. In this way the base, when released and positioned at the level of a groove of a housing portion of the dunnage apparatus, automatically clamps itself without special tools being required for mounting and/or demounting of the protective cap. Since wear and tear of the protective cap may occur after a certain time due to the passage of dunnage material, the measure according to the invention enables an ergonomically simple and fast replacement of a worn protective cap.

In a preferred embodiment of the invention the ring ends are disposed opposite each other in the mounted state in the groove of the housing portion, forming a small gap measuring the few millimetres, preferably 0.5 mm, not exceeding 2 mm. Additionally, a separate spreading device may be inserted into the gap between the ring ends and firmly connected with the housing portion in which the base-receiving groove is formed in such a way that the ring ends are essentially driven apart in circumferential direction in order to increase the clamping forces, thus enlarging the base towards the outside and thereby increasing the outward radial pressure against the housing portion.

In a preferred embodiment of the invention, the spreading device has a wedge structure. The deeper the wedge structure is inserted into the gap, the more the ring ends are driven apart in circumferential direction. Preferably, the spreading structure is an in particular conical screw in threaded engagement with a housing portion in which the base-receiving groove is formed.

In a further development of the invention the articulation arrangement has an articulation for each swing blade. Therein the articulations may be formed in one manufacturing step in that an elastomer material is injection moulded around the base as well as around the swing blade.

Preferably, each articulation is realised as a hinge joint. Therein, the articulation can be formed by means of material thickness reduction and/or as a film hinge.

In order to at least impede reaching through the outlet opening of the dunning apparatus by an operating person towards the forming device, for example in order to remove a possible paper jam, a pivoting movement of the swing blade towards the apparatus, in particular towards a powered forming device of the apparatus, is blocked, wherein a pivoting movement of the swing blades away from the apparatus, in particular from the forming device, is permitted in order to assure an unimpeded flow of the dunnage through the outlet opening out of the dunnage apparatus. In this way the protective cap acts like a check valve, that is for a movement opposite to the transport direction the pivoting movement is blocked or greatly reduced while movement in transport direction is accompanied by unimpeded swinging open of the swing blades to enlarge the clear width of the passage opening defined by the free ends of the swing blades.

In order to block pivoting of the swing blades towards the forming device, preferably each swing blade may have an axial lobe for stopping a movement of the swing blade in blocking direction. The axial lobe can cooperate abuttingly with a round flange of a housing portion of the apparatus. It shall be understood that the axial lobe may also be realised by a flat side of the swing blade extending towards the forming device. The length of the axial lobe merely serves the purpose to adjust the abutting position that is the relative position of the swing blade with respect to the neighbouring housing portions of the dunnage apparatus. Preferably the swing blades are disposed at an in particular equal circumferential distance to each other.

In a preferred embodiment of the invention the swing blades respectively have a convexly curved surface, in particular facing a powered forming device of the apparatus. In this way on the one hand an improved impediment of external access to the forming device is realised and on the other hand the transport flow of the dunnage material out of the apparatus is improved.

Preferably, each of the swing blades may taper towards its free end.

In a preferred embodiment of the invention the base and the swing blades are formed by a rigid plastic, whereas the articulation arrangement is formed by a soft, elastic material, for example TPE with a hardness of about 80 to 90 shore. Preferably, the rigid plastic of the swing blades is a fiber glass reinforced polypropylene. In a preferred embodiment of the invention the protective cap is manufactured by a two-component injection moulding method.

In a preferred embodiment of the invention, several nib-like protrusions are formed of the rigid material of the swing blade and the base and the elastic material of the hinge at the transition between the respective rigid swing blade and/or the rigid base section assigned to the swing blade and the respective soft articulation, which nib-like protrusions extend into the respective other soft or hard material for a toothed engagement. It became apparent that this toothed engagement provides an increased strength of the coupling between the swing blade and/or the base and the soft articulation.

In a preferred embodiment of the invention the nib-like protrusions are respectively designed mushroom-like in the radial cross section and preferably have a hook shape in order to provide a positive engagement between the soft and the rigid material of the respective component. The hook shape may exhibit a hook head extending essentially in transport direction from the outlet opening of the housing support towards the forming device. The hook head may have an axial extension of 0.5 mm to 3 mm. Therein, the protrusions may extend by at least 0.5 mm or 1 mm into the soft material of the articulation.

Furthermore, the invention relates to an apparatus for providing dunnage material dispensed at a dispensing opening of the apparatus. The dunnage apparatus has a protective cap with swing blades according to the invention as named above mounted in a circular, annular groove or annular slot at the dispensing opening.

Preferably, each swing blade has an axial lobe, thus a limitation of movement of the swing blade in a blocking direction opposite to a transport direction of the dunnage material through the apparatus. The axial lobe abuttingly cooperates with a round flange of the housing portion of the apparatus.

In a preferred embodiment of the invention, the round flange is concentric with respect to the base and/or to a groove receiving the base formed in a housing portion of the apparatus, and concentric to a circular cut-off blade disposed downstream of the protective cap. Therein, the round flange may define an internal diameter that essentially corresponds to the internal diameter of a cut-off and/or tear-off edge of the cut-off blade. The cut-off and/or tear-off edge is defined by teeth radially protruding inwards. In this way it is assured that the dunnage material is shaped according to the internal circumferential dimension of the round flange before it comes into contact with the cut-off blade, the internal circumferential dimension of the round flange not being much larger than the internal diameter of the cut-off blade, whereby an undesired catching or even tearing of the dunnage at the cut-off blade is avoided.

In a preferred embodiment of the invention the cut-off blade has teeth radially protruding inwards and extending away from the apparatus at an angle of 0° to 60°, preferably 45° with respect to the transport direction, in particular in transport direction. Thereby, it is assured that dunnage will not catch onto the dunnage apparatus in an undesired way while being conveyed outwards.

Further characteristic, advantages and features of the invention will become apparent by the following description of a preferred embodiment of the invention in conjunction with the attached drawings, in which show:

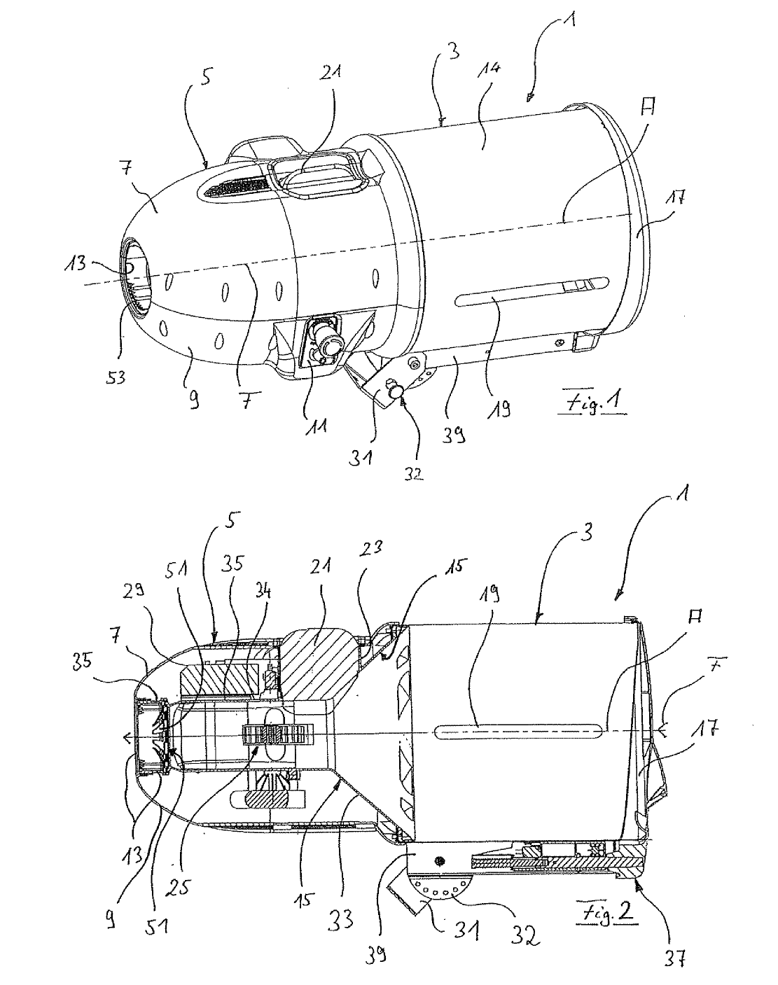

FIG. 1 a perspective view of an apparatus for providing dunnage according to the invention;

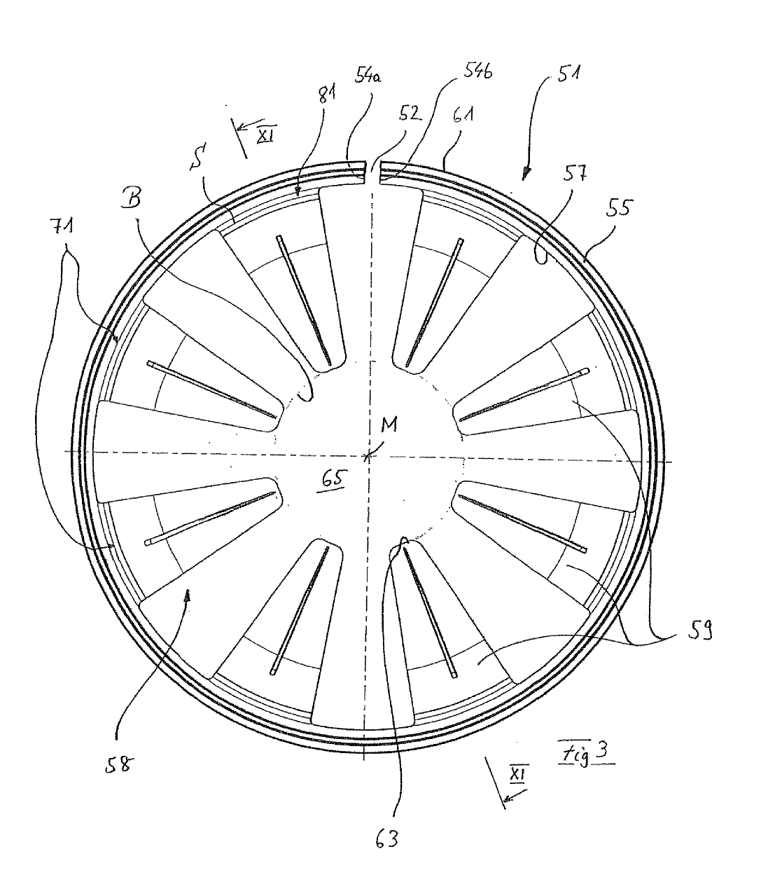

FIG. 2 a cross-sectional view of the apparatus for providing dunnage as in FIG. 1;

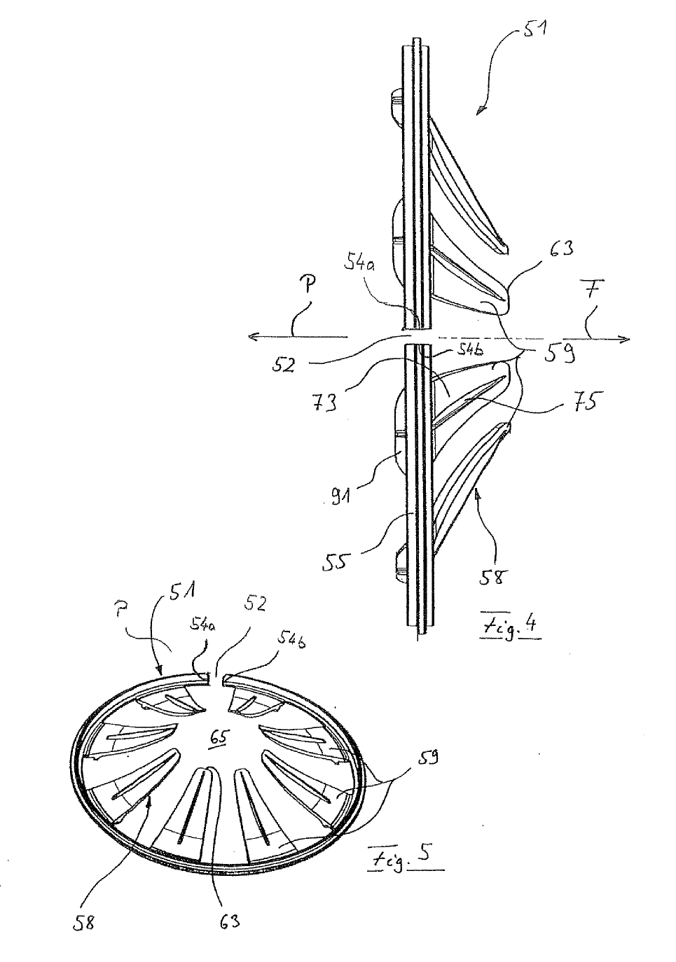

FIG. 3 a top view of a protective cap according to the invention;

FIG. 4 a lateral view of the protective cap according to the invention as in FIG. 3;

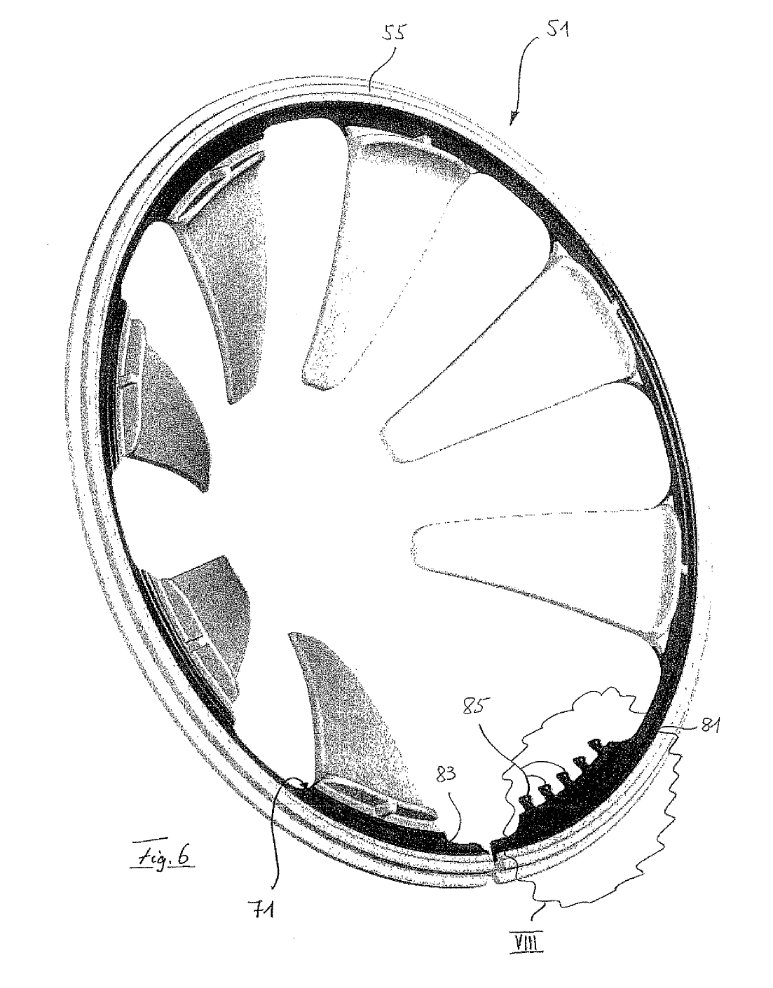

FIG. 5 a perspective view of the protective cap according to the invention as in FIGS. 3 and 4;

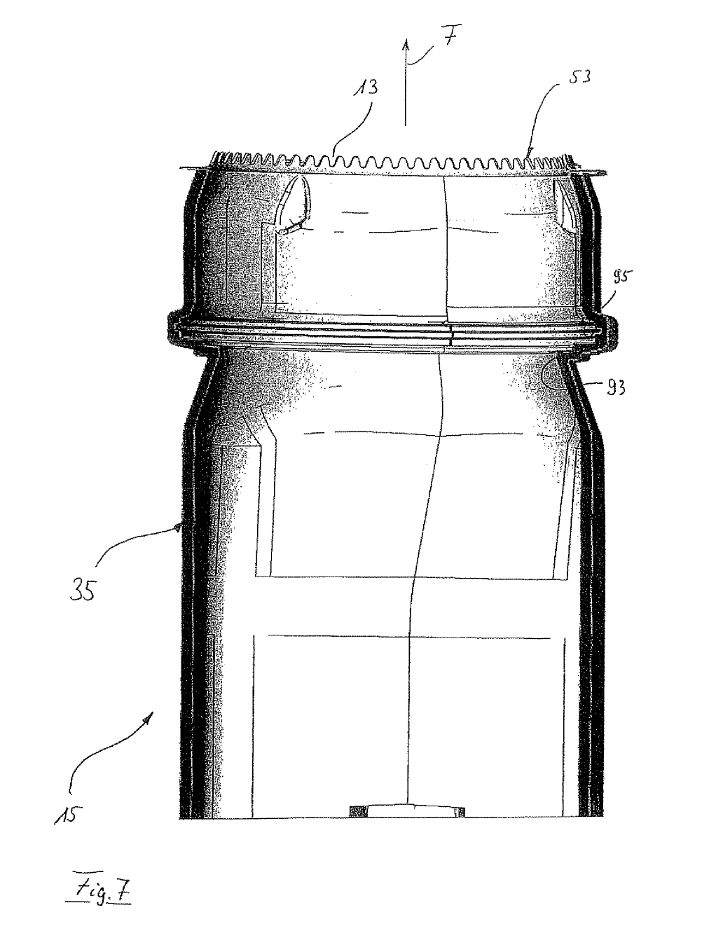

FIG. 6 a further perspective view of the protective cap according to the invention in which one swing blade is omitted for better representation of the coupling of the elastic articulation to the swing blade;

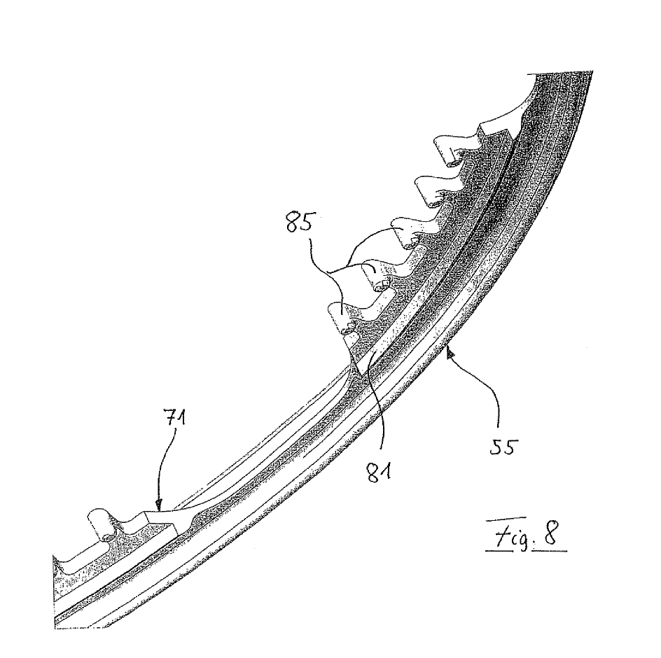

FIG. 7 a cross-sectional view of a housing portion of the dunnage apparatus according to the invention, the housing portion defining the transport path of the dunnage material from the forming device towards the outlet opening; and

FIG. 8 an enlarged perspective detail view of section VIII as in FIG. 6.

In FIGS. 1 and 2 the apparatus for providing dunnage according to the invention is generally given the reference numeral 1. In the following, the apparatus will be referred to as dunnage apparatus 1.

The dunnage apparatus 1 comprises as main components a dunnage material receiving organ 3 and a powered forming section 5 attached thereto covered by two housing shells 7, 9. A control panel 11 with respective controlling regulators and buttons is provided at the outside of the forming section 5.

An outlet opening 13 is delimited among others by recesses at the front of the housing shells 7, 9.

The dunnage material receiving organ 3 consists of a metal cylinder 14 positively connected to a housing support 15 of forming section 5, disposed inside the outer housing shells 7, 9, and closed by a closure lid 17 at its side facing away from the outlet opening 13.

The housing support 15 can be subdivided in a feeder funnel 33, a forming section 34 as well as a dispensing section 35 at the side of the outlet opening 13, the dispensing section 35 being visible in detail in the cross-sectional view in FIG. 7. It shall be understood that all sections, the feeder funnel 33, the forming section 34 as well as the dispensing section 35 can be made from one plastic piece, in particular injection moulded, in particular by two half shell parts coupled to each other.

Within the metal cylinder 14 extends in axial direction A, which essentially corresponds to the transport direction F of the dunnage material, at least one viewing slot 19 by which is indicated to an operating person by how much the dunnage material, like a paper web reeled off the inside of a paper reel disposed inside the dunnage material receiving organ 3, has already been used up. In a compartment 39 separate from the metal cylinder 14 at its bottom side a mechanism 37 is lodged for opening the closure lid 17. The opening mechanism 37 permits pivoting of the closure lid 17 wherein the pivot axis is parallel to the axial direction A of the dunnage apparatus 1 and to transport direction F. Furthermore, the mechanism 37 has a safety device that prevents an operating of the powered forming device 25 when the closure lid 17 is not in the closure position on the metal cylinder 14 shown in FIGS. 1 and 2.

At the forming section 5 a closure plug 21 is removable from the outside, the closure plug being inserted in a penetration shaft 23 formed at the housing support 15, via which manual access to the powered forming device 25 is easily possible, the forming device having a pair of toothed forming wheels for shaping the dunnage material to create a certain dunnage.

The pair of toothed forming wheels is driven by an electric motor 27 of the forming device 25 supported at a side of the housing support 15 opposite to the penetration shaft 23. Within the housing shells 7, 9 a control circuitry 29 is attached to the housing support 15.

The dunnage apparatus 1 comprises at its bottom side a support flange 31 fixed to the dunnage material receiving organ 3 via which the dunnage apparatus 1 can be attached to a vertical support column not shown in detail. By means of the adjustment mechanism 32 that can be designed as an arrangement of a bolt and several holes, the dunnage apparatus 1 can be brought into different pivoting positions relative to the stationary vertical support column and to the horizontal direction in order to facilitate an operating person to direct the dunnage in a desired location.

For operation, first the dunnage material receiving organ 3 is loaded with a material web (not represented) rolled up to a reel. The material web reel is reeled off or pulled off from inside as already described in the generic dunnage apparatus according to DE 10 2005 053 319 A1. The end of the material web is brought from the inside of the reel to a feeder funnel 33 of the housing support 15 via the dunnage material receiving organ 3. A transport direction F of the dunnage material towards the forming device is defined by the cone-shaped internal wall of the feeder funnel 33, through which the dunnage material is fed to the pair of toothed forming wheels of the forming device 25. The motor-powered toothed forming wheels seize the dunnage material and deform it such that the desired dunnage or filler material is formed. The dunnage reaches a dispensing orifice 35 of the housing support 15 defining the outlet opening 13 of the housing support 15.

The speed with which dunnage leaves the outlet opening 13 can be adjusted by the operating person via the operating panel 11 connected with the control circuitry 29.

In the outlet opening 13 the protective cap is positively inserted via a bayonet mount or latchingly inserted into a groove of the internal wall of the outlet opening 13 or in threaded engagement with the internal wall.

Downstream of the insertion position of the protective cap 51 a group of teeth 53 is provided in circumferential sections in the outlet opening in order to facilitate tearing off of the dunnage.

The group of teeth can be formed either by the plastic material of the housing support 15 or by a separate circular metal knife fixed to the free end of the dispensing portion 35 of the housing support 15. Therein, the teeth of the group of teeth 53 can extend at an angle of 0° to 45° with respect to the transport direction F and in transport direction so that the dunnage (not represented in FIG. 7) cannot get caught by the teeth of the group of teeth 53.

As visible in FIG. 7 the dispensing section 35 comprises a round flange 93 protruding inwards and formed upstream by a conical section protruding inwards and downstream by a section radially extending abruptly outwards. The internal diameter of the round flange 93 essentially corresponds to the internal diameter of the group of teeth 53 defined by the ends of the teeth of the group of teeth 53.

A groove or slot 95 is disposed adjacent to the round flange 93, into which the protective cap 51 is clamped. The protective cap 51 comprises an annular base 55, the stepwise outside of which has a shape complementary to the inner side of the groove 95.

In the following details of the protective cap 51 according to the invention are explained referring to FIGS. 3 to 7.

The protective cap 51 according to the invention has as a main component an annular ring base 51, from the internal circumference of which a blocking structure 58 extends radially inwards. The base has a “+”-shaped cross section, wherein one leg extends perpendicularly towards the inner wall of the housing support 15 in order to axially securely fixate the base 55 in an annular groove 95 adjacent to the outlet opening 13. The annular base 55 is not closed but is formed with a radial slot 52 delimited in circumferential direction by opposing ring ends 54a, 54b. The gap 52 allows sliding the ring ends 54a, 54b past each other in essentially circumferential direction of the ring base 55 so that the full circumferential extension is reduced in the state where the ends are slid past each other. Therein, the annular base 55 is elastically deformed so that the internal sections of the annular base 55 are elastically compressed while the external sections of the annular base 55 are elastically compressed. The reduced dimension of the protective cap in circumferential direction allows readily its insertion into the groove 95 via the outlet opening, wherein after releasing the assembly forces from the ring base 55 it deforms into the state shown in FIGS. 3 to 5 like a circlip, whereby pressure against the inside of the groove is generated. In order to generate an increased pressure against the groove surface a spreading device, not represented, can be inserted into the gap 52 between the ring ends 54a, 54b in form of a conical screw and can be brought into threaded engagement with the dispensing section 35 of the housing support 15. The deeper the conical screw is screwed in, the more the ring ends 54a, 54b are driven apart, whereby the pressure of the ring base 55 against the inside of the groove 95 is increased.

The locking structure 58 delimits a passage opening 65 towards the inside and has a circular shape at least in the locking state, which is represented in all of the FIGS. 3 to 6.

In the preferred embodiment of the protective cap 51 shown in FIGS. 3 to 6 the locking structure 58 is formed by eight swing blades or swing arms 59 radially extending towards the centre point M. The swing blades 59 have always an identical outer shape that is wing or blade like and have the shape of isosceles triangles in a top view according to FIG. 3. The base side of the swing blades 59 is disposed at the internal circumference of the ring base 55. The two equal sides of the swing blades 59 extend towards the centre point M. The swing blades 59 do not reach the centre point M but form a free rounded end 63. The free ends 63 of the swing blades 59 are disposed on a (imagined) circular delimiting line B as shown in FIG. 3, defining the circumference of the circular free passage 65. At least in the locked state of the locking structure 58 the delimiting line is circular.

The base side of the swing blades 59 is disposed in the same radial plane as the ring base 55 as shown in FIG. 4.

Each swing blade 59 is curved on both sides and departs from the radial plane of the ring base 55 in a direction away from the forming device 25, as evident from FIG. 2.

Therein, the side 71 of the swing blade 59 facing the forming device 25 forms a convexly curved surface while the side facing away from the forming device 25 forms a concavely curved surface 73. At the concavely curved surface 73 a radially extending reinforcement rib 75 is provided at each swing blade 59.

As evident from FIG. 3 the swing blades 59 radially extend to about two thirds of the radial distance from the ring base 55 to the centre point M. The protective cap 51 according to the invention has an articulation arrangement 71 that is formed by an articulation 81 assigned to each swing blade 59 according to the figures, the articulation consisting of a single elastic material, in particular TPE, without a rigid movable pivot axis. The articulation 81 pivotably connects the swing blade 59 with the ring base 55.

Therein, the articulation is designed such that a pivoting movement of the respective swing blade 59 into the ring base 55 towards the apparatus 1, in particular towards the forming device 25 (in blocking direction P) is blocked while a pivoting movement away from the dunnage apparatus 1, in particular away from the forming device 25 (in transport direction F) is permitted. The articulations 81 respectively define a straight or slightly curved pivot axis S disposed radially inside the internal circumference 57 of the ring base 55.

The articulation 81 is designed as a hinge articulation realised by a material reduction 83 of the elastomer body forming the hinge. The pivot axis S runs along the material thickness reduction 83.

During loading of the swing blades 59 in transport direction F, that is when dunnage is pushed through the outlet opening 13 by the forming device 25, the swing blades 59 are unimpededly opened and thereby the free passage 65 is widened.

Each swing blade 59 is provided with an axial lobe 91 extending essentially in axial direction A towards the apparatus 1 capable of cooperating with the round flange 93 of the housing portion of the dunnage apparatus 1 in order to stop motion in blocking direction P.

The wing type shape of each swing blade 59 has the largest cross section thickness at about its radial centre. In this way, a particularly rigid swing blade structure is created intended to prevent elastic deformation of the swing blade 59 so that reaching into the inside of the dunnage apparatus 1 is prevented as much as possible.

The protective cap 51 can be manufactured by means of a two-component injection moulding procedure in that the rigid component like the ring base 55 and the swing blade 59 are made from a rigid plastic while the articulation arrangement 71 is formed from a softer elastomer material like rubber.

In order to assure solidity of the coupling between the swing blade 59 and the soft material of the articulation arrangement 71, in the area of the transition from the articulation 81 to the swing blade 9 a group of radially inwards extending nibs 85 may be provided, having a mushroom shaped cross section. Furthermore, the nibs 85 are provided with a hook structure, as visible in particular in FIG. 8, wherein a hook head extends opposite to the transport direction away from the outlet opening 30 towards the forming device 25. This group of nibs 85 are formed when during the injection moulding corresponding negative nib shaped free spaces in the swing blades 59 are filled with soft material whereby a positive coupling of the rigid swing blade to the respective articulation 81, adapted to the load, is realised. The soft nibs 85 engage into the rigid material of the swing blades 59.

The features disclosed in the above description, the figures and the claims may be relevant for the realisation of the invention in its different embodiments individually as well as in any combination.

### LIST OF REFERENCE NUMERALS

1 dunnage apparatus

3 dunnage material receiving organ

5, 34 forming section

7, 9 housing shells

11 control panel

13 outlet opening

14 metal cylinder

15 housing support

17 closure lid

19 viewing slot

21 closure plug

23 penetration shaft

25 forming device

27 electric motor

29 control circuitry

31 support flange

32 adjustment mechanism

33 feeder funnel

35 dispensing section

37 opening mechanism

39 compartment

51 protective cap

52 slot

53 group of teeth

54a, 54b opposing ring ends

55 annular base

57 internal circumference

58 locking structure

59 swing blades

61 outer circumference

63 free end

65 passage opening

71 convex side of the swing blade

73 concave side of the swing blade

75 reinforcement rib

81 elastic articulation

83 thickness reduction

85 nibs

91 lobe

93 round flange

95 groove

A axial direction

B delimiting line

F transport direction

M centre point

P blocking direction

S pivot axis

1-25. (canceled)

26. A protective cap for being disposed at an outlet opening of an apparatus for providing dunnage, the protective cap comprising:
an annular, circular, rigid base mountable at the outlet opening;
a plurality of rigid swing blades at least partially extending radially inwards from the base; and
an articulation arrangement for pivotably connecting the swing blades to the base, wherein the annular base is elastically deformable and slotted radially to form two opposite ring ends such that following an elastic deformation, during which the ring ends slide past each other, the base releases clamping forces radially directed outwards in a circlip-type manner.

27. The protective cap according to claim 26, in which the ring ends are facing each other in the mounted state forming a small gap, and a separate spreading device is inserted into the gap and firmly connectable to the apparatus, in particular to a housing portion in which a groove receiving the base is formed, in such a way that the ring ends are essentially driven apart in circumferential direction in order to increase the clamping forces.

28. The protective cap according to claim 27, in which the spreading device has a wedge structure.

29. The protective cap according to claim 26, in which the spreading device is an in particular conical screw in threaded engagement with a housing portion in which a groove receiving the base is formed.

30. The protective cap according to claim 26, in which the articulation arrangement has an articulation for each swing blade.

31. The protective cap according to claim 30, in which each articulation is formed as a hinge joint.

32. The protective cap according to claim 30, in which the articulation is formed by means of a material thickness reduction, as a film hinge, or a combination thereof.

33. The protective cap according to claim 26, in which the pivoting movement of the swing blades towards the apparatus, in particular towards a powered forming device of the apparatus, is blocked, wherein a pivoting movement away from the apparatus, in particular away from the forming device, is allowed.

34. The protective cap according to claim 26, in which each swing blade has an axial lobe for stopping a movement of the swing blade in locking direction, which axial lobe abuttingly cooperates with a round flange of a housing portion of the apparatus.

35. The protective cap according to claim 26, in which the swing blades are arranged at an in particular equal circumferential distance to each other.

36. The protective cap according to claim 26, in which the swing blades respectively have a convexly curved surface facing the apparatus, in particular a powered forming device of the apparatus.

37. The protective cap according to claim 26, in which the swing blades respectively have a concavely curved surface facing away from the apparatus, in particular from a powered forming device of the apparatus.

38. The protective cap according to claim 26, in which each swing blade is tapering towards a free end.

39. The protective cap according to claim 26, in which the base and the swing blades are formed by a rigid plastic, wherein the articulation arrangement is formed by a soft, elastic material, in particular with a Shore hardness of about 80 to 90.

40. The protective cap according to claim 39, in which the rigid plastic of the swing blades is fibre glass reinforced polypropylene.

41. The protective cap according to claim 39, wherein the protective cap is manufactured by means of a two-component injection moulding method.

42. The protective cap according to claim 26, in which several nib-like protrusions are formed by the rigid or by the soft material at a transition between the respective rigid swing blade or a rigid base section and the respective soft articulation, which protrusions extend into the soft or the rigid material for a toothed engagement.

43. The protective cap according to claim 42, in which the protrusions respectively have a mushroom shape for forming a positive toothed engagement between the soft and the rigid material.

44. The protective cap according to claim 42, in which the protrusions extend at least 1 mm into the soft material of the articulation.

45. An apparatus for providing dunnage dispensed at an outlet opening of the apparatus, comprising a protective cap comprising:
an annular, circular, rigid base mountable at the outlet opening;
a plurality of rigid swing blades at least partially extending radially inwards from the base; and
an articulation arrangement for pivotably connecting the swing blades to the base, wherein the annular base is elastically deformable and slotted radially to form two opposite ring ends such that following an elastic deformation, during which the ring ends slide past each other, the base releases clamping forces radially directed outwards in a circlip-type manner; and wherein the protective cap is mounted in a circular groove at the outlet opening.

46. The apparatus according to claim 45, in which each swing blade has an axial lobe for stopping a movement of the swing blade in locking direction, which axial lobe abuttingly cooperates with a round flange of a housing portion of the apparatus.

47. The apparatus according to claim 46, in which the round flange is formed concentrically with respect to the base and/or to a groove receiving the base and being formed in a housing portion of the apparatus, and to an annular cut-off blade disposed downstream of the protective cap in transport direction.

48. The apparatus according to claim 47, in which the round flange defines an internal diameter corresponding essentially to the internal diameter of a cut-off edge, teare-off edge, or combination thereof of the cut-off blade.

49. The apparatus according to claim 48, in which the cut-off edge, teare-off edge, or combination thereof of the cut-off blade is defined by teeth radially protruding inwards.

50. The apparatus according to claim 48, in which the cut-off blade has teeth radially protruding inwards and extending away from the apparatus at an angle of 0° to 60° with respect to an axial transport direction of the dunnage, in particular in transport direction.
